(19) United States
(12) Patent Application Publication
(10) Pub. No.: US 2008/0012183 A1
(43) Pub. Date: Jan. 17, 2008

(54) Process of forming a planed layer

(76) Inventors: Jin Wuk Kim, Uiwang-si (KR); Yeon Heui Nam, Gangneung-si (KR)

Correspondence Address: MCKENNA LONG & ALDRIDGE LLP, 1900 K STREET, NW, WASHINGTON, DC, 20006, US

(21) Appl. No.: 11/637,682

(22) Filed: Dec. 13, 2006

(30) Foreign Application Priority Data
Jun. 30, 2006 (KR) P2006-061214
Oct. 19, 2006 (KR) P2006-101734

(51) Int. Cl. B29C 35/08; B29C 43/02; B29C 71/00; B29C 71/04; B29C 33/40

(52) U.S. Cl. 264/496; 264/319; 264/236; 264/337

(57) ABSTRACT

A method for fabricating a color filter substrate for a liquid crystal display (LCD) device includes forming red (R), green (G) and blue(B) color filters in color filter areas on a substrate; forming an overcoating layer on the R, G and B color filters; arranging a mold on the overcoating layer; performing a first curing process on the overcoating layer through the mold; removing the mold from the overcoating layer; and performing a second curing process on the overcoating layer after removing the mold.

This application claims the benefit of the Korean Patent Application No. P2006-0061214, filed on Jun. 30, 2006, which is hereby incorporated by reference as if fully set forth herein.

### BACKGROUND OF THE INVENTION

1. Field of the Invention

The present invention relates to integrated circuit (IC) chips and flat panel display (FPD) devices and, more particularly, to a method for fabricating a substrate with a planarization layer for ICs and FPD devices.

2. Discussion of the Related Art

In general, integrated circuit (IC) chips and flat panel display (FPD) devices include a plurality of electrical circuits embodied by patterns and layers of semiconductor materials, insulating materials, conductive materials, filtering materials and the like. A planarization layer is usually formed on the underlying patterns and layers to produce a flat surface. For example, the color filter substrate of a liquid crystal display (LCD) device includes an overcoating layer for the planarization purpose.

The color filter substrate includes color filters of three primary colors of red (R), green (G) and blue (B) formed on a transparent substrate (e.g., glass substrate). The overcoating layer is formed on the color filters to protect the color filters and planarize the contours of the color filters.

A white (W) filter area has been recently added to the color filter substrate besides the RGB color filters. The white filter area has no filter material on the glass substrate. Accordingly, a stepped portion, called the “yellowish,” occurs along the boundaries between the white filter area and the areas of the color filters on the surface of the overcoating layer formed on the top of the color filter layer.

To prevent the occurrence of such a stepped portion, an in-plane printing (IPP) method has been suggested as a method for forming an overcoating layer on a color filter substrate. The IPP method will now be described with reference to FIGS. 1A and 1B.

Referring to FIG. 1A, the surface of a glass substrate 11 is divided into color filter areas (CA) and white filter areas (WA). Color filter patterns 13 formed of red, green and blue filter materials are formed on the glass substrate 11 in the color filter areas (CA). Because no filter pattern is arranged in the white filter areas (WA), the surface regions of the glass substrate 11 corresponding to the white filter areas (WA) are exposed so that red, green and blue lights pass through the white filter areas (WA) to display white color (W).

The height difference (T) at the boundaries between the white filter areas (WA) and the color filter areas (CA) is approximately 3 μm. An overcoating material layer 15 of resin, such as polyurethane, etc. is formed on the glass substrate 11 having the color filter patterns 13.

A mold 17 is placed on the overcoating material layer 15 to planarize the surface of the overcoating material layer 15. That is, the mold 17 contributes to compensating the uneven surface of the overcoating material layer 15 generated by the color filter patterns 13.

Referring to FIG. 1B, the mold 17 is then removed from the surface of the overcoating material layer 15. An annealing process such as a hard-baking process is performed on the color filter patterns 13 and overcoating material layer 15.

However, during the hard-baking process, the overcoating material layer 15 contracts and the thickness of the overcoating material layer 15 decreases. For example, if the thickness of the overcoating material layer 15 decreases about 10%, step portions having a height (t) of about 0.3 μm are formed between the surface regions of the overcoating material layer 15 positioned on the color filter areas (CA) and the other surface regions of the overcoating material layer 15 positioned on the white filter areas (WA). That is, the surface of the overcoating material layer 15 becomes uneven after the hard-baking process of the IPP method.

FIGS. 2A and 2B are perspective photographs illustrating the surface of an overcoating layer formed by the conventional IPP method. FIG. 2A illustrates the surface of the overcoating material layer 15 after being planarized by the mold 17. FIG. 2B illustrates the step portions formed after an annealing process such as a hard-baking process.

In FIG. 2B, the yellow belts are shown at the boundaries between the color filter areas (CA) and the white filter areas (WA). These yellow belts are caused by the stepped portions formed after the hard-backing process and thus are called the “yellowish.”

As described above, the conventional IPP method has limitations in producing a flat surface for IC chips and FPD devices.

### SUMMARY OF THE INVENTION

Accordingly, the present invention is directed to a method for fabricating a substrate with a planarization layer that substantially obviates one or more problems due to limitations and disadvantages of the related art.

An advantage of the present invention is to provide a method for fabricating a substrate with a planarization layer for ICs and FPD devices.

Additional features and advantages of the invention will be set forth in the description which follows, and in part will be apparent from the description, or may be learned by practice of the invention. These and other advantages of the invention will be realized and attained by the structure particularly pointed out in the written description and claims hereof as well as the appended drawings.

To achieve these and other advantages and in accordance with the purpose of the invention, as embodied and broadly described herein, a method for fabricating a substrate for an electronic device includes forming a layer on a substrate; arranging a mold on the layer; performing a first curing process on the layer with the mold; removing the mold from the layer; and performing a second curing process on the layer.

In another aspect of the present application, a method for fabricating a color filter substrate for a liquid crystal display (LCD) device includes forming red (R), green (G) and blue (B) color filters in color filter areas on a substrate; forming an overcoating layer on the R, G and B color filters; arranging a mold on the overcoating layer; performing a first curing process on the overcoating layer through the mold; removing the mold from the overcoating layer; and performing a second curing process on the overcoating layer after removing the mold.

It is to be understood that both the foregoing general description and the following detailed description are exemplary and explanatory and are intended to provide further explanation of the invention as claimed.

### BRIEF DESCRIPTION OF THE DRAWINGS

The accompanying drawings, which are included to provide a further understanding of the invention and are incorporated in and constitute a part of this specification, illustrate embodiments of the invention and together with the description serve to explain the principles of the invention.

In the Drawings

FIGS. 1A and 1B are portional views illustrating a method of a color filter substrate with an overcoating layer according to the related art;

FIGS. 2A and 2B are perspective photographs illustrating the uneven surface of an overcoating layer formed by the conventional IPP method;

FIGS. 3A to 3C are sectional views illustrating a method of fabricating a color filter substrate for a liquid display device according to the first embodiment of the present invention; and

FIGS. 4A to 4C are sectional views illustrating a method of fabricating a color filter substrate for a liquid display device according to the second embodiment of the present invention.

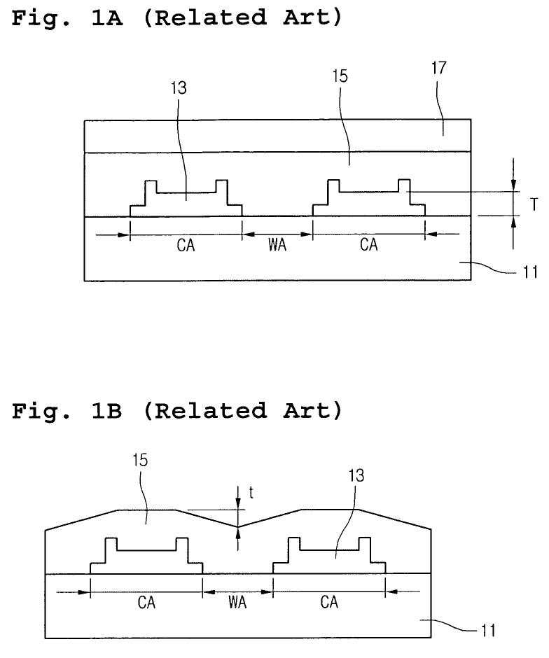

### DETAILED DESCRIPTION OF THE ILLUSTRATED EMBODIMENT

Reference will now be made in detail to embodiments of the present invention, examples of which are illustrated in the accompanying drawings.

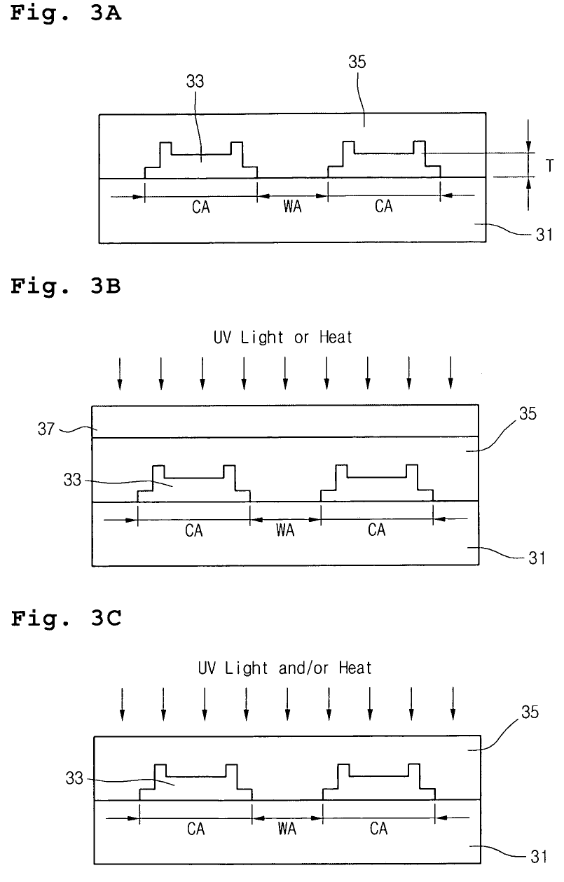

FIGS. 3A to 3C are sectional views illustrating a method of fabricating a color filter substrate for a liquid display device according to the first embodiment of the present invention.

Referring to FIG. 3A, the surface of a glass substrate 31 is divided into color filter areas (CA) and white filter areas (WA). Color filter patterns 33 formed of red, green and blue filter materials are formed on the glass substrate 31 in the color filter areas (CA). Because no filter pattern is arranged in the white filter areas (WA), the surface regions of the glass substrate 31 corresponding to the white filter areas (WA) are exposed so that red, green and blue lights pass through the white filter areas (WA) to display white color (W).

The height difference (T) at the boundaries between the white filter areas (WA) and the color filter areas (CA) is approximately 3 μm. An overcoating material layer 35 is formed on the glass substrate 31 having the color filter patterns 33. The overcoating material layer 35 is beneficially formed of an UV curable liquid pre-polymer, thermal curable liquid pre-polymer, or thermal curable liquid pre-polymer having an UV component. The overcoating material layer 35 further includes an initiator such as phosphine oxide or an aromatic ketone type, etc.

Referring to FIG. 3B, a mold 37 is placed on the overcoating material layer 35 to apply a uniform contact to the surface of the overcoating material layer 35 to planarize the surface of the overcoating material layer 35. The mold 37 is generally made of polydimethylsiloxane (PDMS), polyurethane acrylates, silicone etc. That is, the mold 37 contributes to compensating the uneven surface of the overcoating material layer 35 generated by the color filter patterns 33.

A first curing is then performed on the overcoating material layer 35 by irradiating an UV light or heat. When the overcoating material layer 35 is formed of an UV curable liquid pre-polymer, an UV light is irradiated on the overcoating material layer 35 through the transparent mold 37. When the overcoating material layer 35 is formed of a thermal curable liquid pre-polymer or thermal curable liquid pre-polymer having an UV (reaction) component, a heat treatment is performed on the overcoating material layer 35 with the mold 37.

The UV light has a strength of 5 to 11 mW/cm² and a wavelength (λ) of 300 to 500 nm. The UV light is applied to the overcoating material layer 35 for 3 to 15 minutes. For the thermal curing process, the overcoating material layer 35 is cured at a temperature between 60° C. and 140° C. for 5 minute to 24 hours.

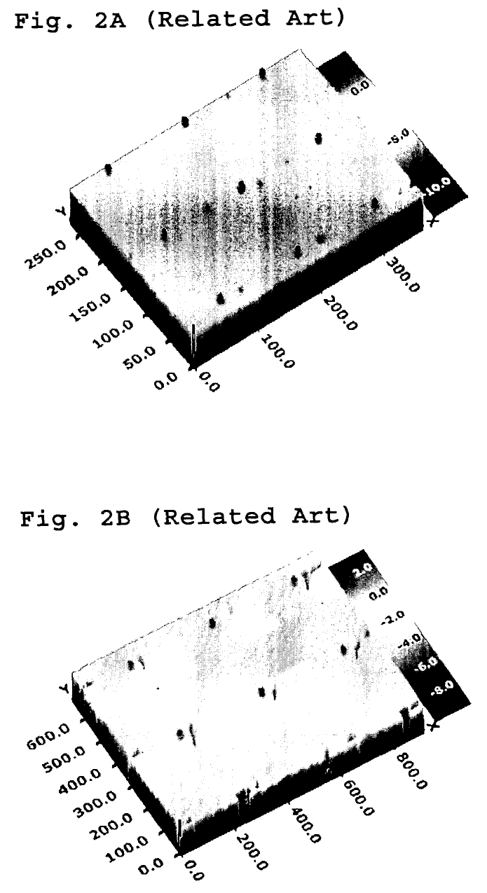

Upon the irradiation of the UV light, the liquid pre-polymers contained in the overcoating material layer 35 are molecularly bonded together or cross-linked. In this way, the overcoating material layer 35 is primarily hardened (or solidified) by the UV irradiation and has a high thermal stability. As a result, the surface of the overcoating material layer 35 becomes planarized, as illustrated in FIG. 2A.

Referring to FIG. 3C, after the primary hardening of the overcoating material layer 35, the mold 37 is removed from the overcoating material layer 35 to expose the surface of the overcoating material layer 35. Then, a second curing process is performed on the overcoating material layer 35.

When the overcoating material layer 35 is formed of an UV curable liquid pre-polymer or thermal curable liquid pre-polymer having an UV (reaction) component, an UV light is irradiated on the overcoating material layer 35. When the overcoating material layer 35 is formed of a thermal curable liquid pre-polymer, a heat treatment is performed on the overcoating material layer 35. The process conditions of the second curing process using the UV light are similar to the process conditions of the first curing process using the UV light. To be sure, when the overcoating material layer 35 is formed of a thermal curable liquid pre-polymer having an UV (reaction) component, an UV light is used for the first curing process and a heat is applied to the overcoating material layer 35 for the second curing process after removing the mold 37.

For the second curing process of the thermal curable liquid pre-polymer, the overcoating material layer 35 is cured at a temperature of about 230° C. for 5 minutes to 24 hours, which is similar to the curing conditions of a polyimide layer that will be formed on the overcoating material layer 35 to orient the molecules of liquid crystal.

Due to the second curing process, the liquid pre-polymer remaining in the overcoating material layer 35 are further molecularly bonded together and the density of the cross-linking between the molecules of the overcoating material layer 35 becomes higher.

Accordingly, the molecular weight and the binding force of the molecules in the overcoating material layer 35 further increase and the overcoating material layer 35 is more firmly hardened. The overcoating material layer 35 hardened by the first and second curing processes has a higher thermal stability with a lesser contraction. Also, the overcoating material layer 35 according to the first embodiment of the present invention has substantially no step portion at the boundaries between the color filter areas (CA) and the white filter areas (WA), thereby minimizing or preventing the yellowish phenomenon.

Moreover, it is possible to control the molecular weight, the molecular binding force and the thermal stability of the overcoating material layer 35 by varying an amount of the initiator.

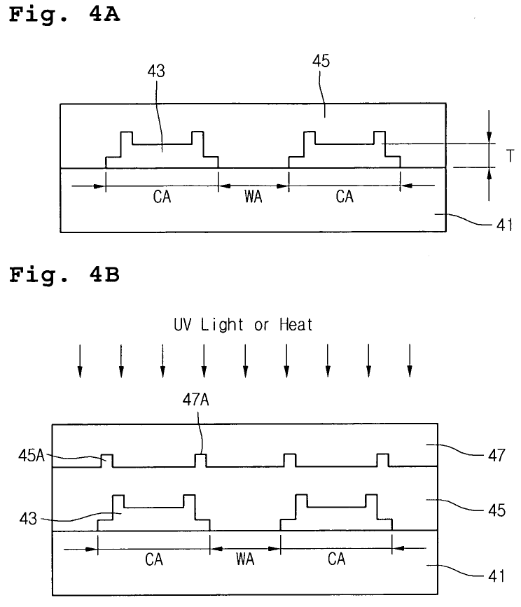

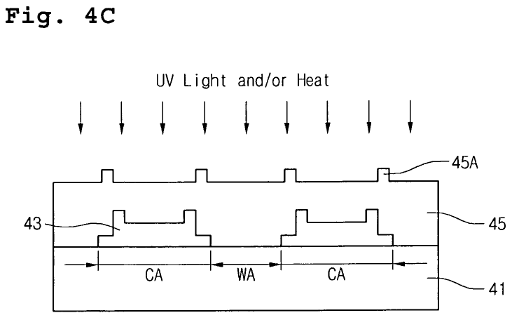

FIGS. 4A to 4C are sectional views illustrating a process for forming a color filter substrate for a display device according to the second embodiment of the present invention.

Referring to FIG. 4A, the surface of a glass substrate 41 is divided into color filter areas (CA) and white filter areas (WA). Color filter patterns 43 formed of red, green and blue filter materials are formed on the glass substrate 41 in the color filter areas (CA). Because no filter pattern is arranged in the white filter areas (WA), the surface regions of the glass substrate 41 corresponding to the white filter areas (WA) are exposed so that red, green and blue lights pass through the white filter areas (WA) to display white color (W).

The height difference (T) at the boundaries between the color filter areas (CA) and the white filter areas (WA) is approximately 3 μm. An overcoating material layer 45 is formed on the glass substrate 41 having the color filter patterns 43. The overcoating material layer 45 is beneficially formed of an UV curable liquid pre-polymer, thermal curable liquid pre-polymer, or thermal curable liquid pre-polymer having an UV (reaction) component. The overcoating material layer 45 further includes an initiator such as phosphine oxide or an aromatic ketone type, etc.

Referring to FIG. 4B, a mold 47 is placed on the overcoating material layer 45 to apply a uniform contact to the surface of the overcoating material layer 45 to planarize the surface of the overcoating material layer 45. The mold 47 is generally made of polydimethylsiloxane (PDMS), polyurethane acrylates, silicone etc. That is, the mold 47 contributes to compensating the uneven surface of the overcoating material layer 45 generated by the color filter patterns 43.

The mold 47 includes a plurality of concave portions 47A. After the mold 47 is placed on the overcoating material layer 45, the concave portions 47A are filled with the overcoating material by a capillary force, thereby forming a concave coating material pattern 45A. The concave coating material pattern 45A is used as a spacer for maintaining a constant gap between a thin film transistor substrate and the color filter substrate.

A first curing is then performed on the overcoating material layer 45 on which the transparent mold 47 having such concave portions 47A is placed. When the overcoating material layer 45 is formed of an UV curable liquid pre-polymer, an UV light is irradiated on the overcoating material layer 45 through the transparent mold 47. When the overcoating material layer 45 is formed of a thermal curable liquid pre-polymer or thermal curable liquid pre-polymer having an UV (reaction) component, a heat treatment is performed on the overcoating material layer 45 with the mold 47.

The UV light has a strength of 5 to 11 mW/c² and a wavelength (λ) of 300 to 500 nm. The UV light is applied to the overcoating material layer 45 for 3 to 15 minutes. For the thermal curing process, the overcoating material layer 45 is cured at a temperature between 60° C. and 140 for 5 minute to 24 hours.

Upon the irradiation of the UV light, the liquid pre-polymers contained in the overcoating material layer 45 and the overcoating material pattern 45A are molecularly bonded together or cross-linked. Accordingly, the molecular weights of the overcoating material layer 45 and the overcoating material pattern 45A increase and the binding forces of the molecules of the overcoating material layer 45 and the overcoating material pattern 45A also increase. In this way, the overcoating material layer 45 and the overcoating material pattern 45A are primarily hardened by the UV irradiation and have a high thermal stability. As a result, the planarized surface of the overcoating material layer 45 and the overcoating material pattern 45A are formed at the same time. Moreover, the process of forming the overcoating material layer 45 and the overcoating material pattern 45A is simplified.

Referring to FIG. 4C, after the primary hardening of the overcoating material layer 45 and the overcoating material pattern 45A, the mold 47 is removed from the overcoating material layer 45 to expose the surface of the overcoating material layer 45 and the overcoating material pattern 45A. Then, a second curing process is performed on the overcoating material layer 45 and overcoating material pattern 45A.

When the overcoating material layer 45 is formed of an UV curable liquid pre-polymer or thermal curable liquid pre-polymer having an UV (reaction) component, an UV light is irradiated on the overcoating material layer 45. When the overcoating material layer 45 is formed of a thermal curable liquid pre-polymer, a heat treatment is performed on the overcoating material layer 45. The process conditions of the second curing process using the UV light are similar to the process conditions of the first curing process using the UV light. To be sure, when the overcoating material layer 45 is formed of a thermal curable liquid pre-polymer having an UV (reaction) component, an UV light is used for the first curing process and a heat is applied to the overcoating material layer 45 for the second curing process after removing the mold 47.

For the second curing process of the thermal curable liquid pre-polymer, the overcoating material layer 45 is cured at a temperature of about 230 for 5 minute to 24 hours, which is similar to the curing conditions of a polyimide layer that will be formed on the overcoating material layer 35 to orient the molecules of liquid crystal.

Due to the second curing process, the liquid pre-polymer remaining in the overcoating material layer 45 and the overcoating material pattern 45A are further molecularly bonded together and the density of the cross-linking between the molecules of the overcoating material layer 45 and the overcoating material pattern 45A becomes higher.

Accordingly, the molecular weight and the binding force of the molecules in the overcoating material layer 45 and the overcoating material pattern 45A further increase and the overcoating material layer 45 and the overcoating material pattern 45A are more firmly hardened. The overcoating material layer 45 and the overcoating material pattern 45A hardened by the first and second curing processes have a higher thermal stability with a lesser contraction. Also, the overcoating material layer 45 according to the second embodiment of the present invention has substantially no step portion at the boundaries between the color filter areas (CA) and the white filter areas (WA), thereby minimizing or preventing the yellowish phenomenon. In addition, because the overcoating material pattern 45A that can be used as a spacer is fabricated together with the overcoating material layer 45, it is possible to simplify the fabricating process of the color filter substrate of an LCD device.

As described above, the planarization layer according to the present invention is formed by the first and second curing processes. Because of the double curing process, the planarization layer is hardened with a lesser contraction and higher thermal stability. As a result, the planarization layer according to the present invention has substantially no step portion at the boundaries between the color filter areas (CA) and the white filter areas (WA), thereby minimizing or preventing the yellowish phenomenon. Moreover, because the planarization layer can be simultaneously formed with a spacer, it is possible to simplify the fabricating process of a display device.

The present invention is described with examples of forming an overcoating material layer on a color filter substrate of a liquid crystal display (LCD) device. However, it should be understood that the principles of the present invention can be readily applied to IC chips, plasma display panels (PDPs), electroluminescence displays (ELs), and other types of display devices.

It will be apparent to those skilled in the art that various modifications and variation can be made in the present invention without departing from the spirit or scope of the invention. Thus, it is intended that the present invention cover the modifications and variations of this invention provided they come within the scope of the appended claims and their equivalents.

What is claimed is:

1. A method for fabricating a substrate for an electronic device, the method comprising:
forming a layer on a substrate;
arranging a mold on the layer;
performing a first curing process on the layer with the mold;
removing the mold from the layer; and
performing a second curing process on the layer.

2. The method according to claim 1, wherein the layer includes at least one of an ultraviolet (UV) curable liquid pre-polymer, a thermal curable liquid pre-polymer and a thermal curable liquid pre-polymer having an UV component.

3. The method according to claim 2, wherein the layer further includes an initiator.

4. The method according to claim 2, wherein the mold is made of one of polydimethylsiloxane (PDMS), polyurethane acrylates and silicone.

5. The method according to claim 2, wherein when the layer includes the UV curable liquid pre-polymer, the first and second curing processes are performed by irradiating an UV light on the layer.

6. The method according to claim 5, wherein the mold is substantially transparent.

7. The method according to claim 5, wherein the UV light has a strength of about 5 to about 11 mW/cm² and a wavelength (λ) of about 300 to about 500 nm.

8. The method according to claim 7, wherein the UV light is irradiated on the layer for about 3 to about 15 minutes.

9. The method according to claim 2, wherein when the layer includes the thermal curable liquid pre-polymer, the first and second curing processes are performed by applying a heat on the layer.

10. The method according to claim 9, wherein the first curing process is performed at a temperature between about 60° C. and about 140° C. for about 5 minute to about 24 hours.

11. The method according to claim 10, wherein the second curing process is performed at a temperature of about 230° C. for about 5 minutes to about 24 hours

12. The method according to claim 2, wherein when the layer includes the thermal curable liquid pre-polymer having an UV component, the first curing process is performed by irradiating a UV light and the second curing process is performed by applying a heat on the layer.

13. The method according to claim 3, wherein an amount of the initiator controls an amount of molecular bonding of the layer.

14. The method according to claim 1, wherein the mold has a plurality of concave portions.

15. The method according to claim 14, wherein an electronic pattern is simultaneously formed with the layer corresponding to the concave portions of the mold for the electronic device.

16. A method for fabricating a color filter substrate for a liquid crystal display (LCD) device, the method comprising:
forming red (R), green (G) and blue (B) color filters in color filter areas on a substrate;
forming an overcoating layer on the R, G and B color filters;
arranging a mold on the overcoating layer;
performing a first curing process on the overcoating layer through the mold;
removing the mold from the overcoating layer; and
performing a second curing process on the overcoating layer after removing the mold.

17. The method according to claim 16, wherein the color filter areas include an white (W) color filter area in which no filter material is formed.

18. The method according to claim 16, wherein the overcoating layer includes at least one of an ultraviolet (UV) curable liquid pre-polymer, a thermal curable liquid pre-polymer and a thermal curable liquid pre-polymer having an UV component.

19. The method according to claim 18, wherein at least one of the first and second curing processes is performed by irradiating an UV light on the overcoating layer.

20. The method according to claim 19, wherein the mold is substantially transparent.

21. The method according to claim 19, wherein the UV light has a strength of about 5 to about 11 mW/cm² and a wavelength (λ) of about 300 to about 500 nm.

22. The method according to claim 19, wherein the UV light is irradiated on the overcoating layer for about 3 to about 15 minutes.

23. The method according to claim 16, wherein the mold has a plurality of concave portions.

24. The method according to claim 23, wherein a plurality of column spacers are simultaneously formed with the overcoating layer corresponding to the concave portions of the mold and the column spacers maintain a cell gap of the LCD device.
